(19) United States
(12) Patent Application Publication
(10) Pub. No.: US 2009/0242539 A1
(43) Pub. Date: Oct. 1, 2009

(54) Heating System

(76) Inventor: Damian A. Wassel, Warrenton, VA (US)

Correspondence Address: GREENBERG & LIEBERMAN, LLC, 2141 WISCONSIN AVE, N.W., SUITE C-2, WASHINGTON, DC, 20007, US

(21) Appl. No.: 12/060,534

(22) Filed: Apr. 1, 2008

(51) Int. Cl. H05B 3/36; H05B 1/00

(52) U.S. Cl. 219/240; 219/211

(57) ABSTRACT

A heating system that provides long lasting and all-encompassing heat to the hands of a skier or snowmobile/motorcycle user. A power source, such as a battery, is secured within a hollow portion of each handgrip. In the wired version, a conduit passes through the wrist strap attached to each ski pole handgrip and connects with each glove, where conductive wires sewn into the glove fabric carry the power to strategically placed heating elements also sewn into the glove fabric, which in turn provides heat to the skier's hands. The wireless version features an interface and various contact points between the gloves and handgrips, and may be applied to both ski poles and handlebars of snowmobiles and motorcycles.

### FIELD OF THE INVENTION

The present invention is a heating system for recreational users—particularly skiers and motorcycle/snowmobile riders—employing a power source such as a battery located within the handgrips of associated ski poles or handlebars, along with wired or wireless conduits that transfer power from the handgrips to heating elements contained within each glove.

### BACKGROUND OF THE INVENTION

Skiing continues to be an ever-popular winter sport. Millions of people ranging from young children to senior citizens flock to ski areas around the globe every year. It does not matter whether the conditions are relatively warm or extremely cold, as many skiers are not deterred. Instead, skiers facing cold temperatures bundle up to keep warm as they navigate mountains, hills or cross-country locations.

In fact, an entire niche industry relating to clothing for skiers is prevalent within the marketplace. A primary reason is that comfort during a ski outing is paramount to whether or not the skier achieves a positive experience. An ill prepared skier can conceivably face an uncomfortable and even painful outing. Gloves in particular are especially important to this endeavor. However, a skier can face potentially dangerous issues relating to the cold if his or her hands are not kept warm. This is particularly true while waiting in line and riding on ski lifts. In addition, similar issues relate to users of snowmobiles and motorcycles. Even with high-quality gloves, various predicaments such as snow finding its way inside the gloves and overall cold temperatures can still cause discomfort and potential health risks. Because of this, there remains a need for a glove that will assure skiers and motorized vehicle users that their hands will remain warm no matter the level of frigid temperature.

Many ski-clothing experts actually recommend that skiers wear mittens instead of gloves due to the increased containment of body heat among the fingers. However, many skiers do not like to sacrifice finger dexterity by choosing mittens over gloves. In that regard, loose fitting gloves with thick insulation is often recommended. While this option can be effective, skiers sometimes complain of snow and cold air sneaking into their gloves. Frigid temperatures caused by riding on snowmobiles or motorcycles, as well as while riding on ski lifts also complicate these outings. This issue further forces skiers to get creative with their sleeves and clothing layers in order to protect their hands from extreme cold temperatures. In the end, ski-clothing experts often recommend that skiers place chemical heat packs inside their gloves or mittens. These chemical heat packs are often sold as impulse items at specialty shops and ski resorts. However, chemical heat packs are typically thrown into the garbage once their heating lifespan expires. This means that skiers often have to replace chemical heat packs in the middle of a ski outing, particularly while night skiing. In addition, skiers often complain that certain chemical heat packs focus on heating the direct areas of their placement and are not efficient in heat dispersion. Chemical heat packs also typically are not adjustable in terms of amount of heat produced and also may not be turned off once initiated. Because of these issues, there remains a need for a system that provides convenient and renewable heat to a skier's hands while at the same time provides even dispersion of this heat to all areas of a skier's hands. The present invention satisfies this need through its unique heating system. Unlike the existing methods and heating innovations, the present invention includes a power source within a handgrip associated with a ski pole or handlebar that connects through an unobtrusive conduit to heating elements sewn into various strategic locations of the gloves for evenly dispersed and long-lasting heat to the hands. In addition, the present invention is much more conducive to heating the hands at the most important times. An example includes ski lift time. Unlike other heating devices, the present invention allows the user to engage in either the wired or wireless embodiments of the present invention at a time of his or her choosing. So if a user on a ski lift realizes that his or her hands are cold, the user can receive heat through the connection associated with the power source located in the protected confines of the handgrip. At the same time, if the user does not wish to receive additional heat, he or she can disconnect the glove from handgrip. This is important because in that way, the present invention preserves power and only utilizes the power source when needed.

U.S. Pat. No. 7,307,242 filed by Chen and published on Dec. 12, 2007 is a heating device for a glove. Chen requires that a battery set be attached to the actual glove where the power generated from these batteries via a control mechanism enable carbon fiber filaments to generate heat. Unlike the present invention, Chen specifically requires filaments that are constructed in carbon fiber. In contrast, the present invention utilizes various heating elements to include electrically charged heat transmitting gel, along with other conventional filaments and heating elements that are not necessarily limited to carbon fiber. Moreover, Chen limits itself to placing a battery set onto the actual glove. This fact is important because the battery set would be exposed to various extreme elements such as snow and ice if Chen were used in a more extreme activity. The present invention, in contrast, is not meant for everyday glove use during cold temperatures. Instead, the present invention is specifically designed for the rigors and environmental issues associated with skiing. For example, the power source of the present invention is sealed and contained within the ski pole handgrip. This aspect protects the power source from moisture and trauma as the power source of the present invention is naturally protected by the ski pole and ski pole handgrip. This is in stark contrast to Chen, which could conceivably fail if a skier's gloved hand is jolted through a fall or submerged in snow or puddle water. It also should be noted that it is potentially dangerous for a battery set to be located anywhere on the body to include the glove, as is the case with Chen because it causes an additional injury point due to its hard nature. A glove-mounted battery pack such as described in Chen and similar versions of Chen also would have to be relatively small or else the battery pack would be both cumbersome and cause potential injury such as hand breaks or bruises during falls or accidents. However, the flaw in Chen that is rectified with the present invention is that such a small battery pack as described in Chen would not possess enough power supply to be an efficient, durable and long-lasting heat source. By placing the power source in the handgrip of a ski pole or handlebar, the present invention can hold and isolate a large enough power source away from outside elements to last an entire outing while also permit the user to employ higher-temperature heating if necessary.

U.S. Pat. No. 4,440,421 issued to Adamson on Apr. 3, 1984, is a ski pole grip with electrical heating. Adamson focuses on its primary aspect as a ski pole hand shield that also contains a hand-warming function by placing a battery into the interior of the handgrip. Unlike the present invention, Adamson heats the hand area by requiring the skier to wrap his or her hand around the hand shield to be gripped. This means that with Adamson, every time a skier releases his or her grip, the handgrip will go cold and would then require much more drainage of power to reheat the grip upon return by the skier. Moreover, Adamson does not provide optimal and all-encompassing heat for the hands as does the present invention through the use of strategically placed heating elements within the glove. Additional items relating to heated handgrips such as U.S. Pat. No. 6,756,573 (heated golf club grip), U.S. Pat. No. 6,164,003 (heated firearm stock), and U.S. Pat. No. 5,934,267 (heated hand grip for archery bow) all relate to the same flaws attributed to Adamson.

Adamson also is flawed in that the shield is inherently dangerous to skiers because when a skier takes a fall or gets tied up with another skier, etc, the skier needs to be able to immediately let go of the ski pole handgrip. The shield in Adamson impedes this crucial aspect and subjects skiers to broken fingers, wrists and even arm injuries. The present invention, in contrast, employs a wired version via a conduit ingrained into the flexible and natural wrist strap of a handgrip in relation to skiing, and a wireless version for handgrips related to skiing and snow mobiles/motorcycles that obviously do not possess the same level of danger as the shield of Adamson.

There are a number of other items on the market similar to Chen relating to gloves that receive heat through battery packs. However, those gloves route relatively long wires from battery packs located through such items as clothing to the gloves. These attempts cause the aforementioned problem of injury points, especially when it comes to skiers and snow mobile/motorcycle users. Moreover, routing wires through bulky coats and other clothing is awkward, uncomfortable and becomes a nuisance every time the person would remove his or her coat.

Because of the aforementioned issues, there remains a need for a system that can safely, effectively and conveniently provide long lasting heat to all parts of a skier's hands. In addition, this need also relates to other cold-weather activities such as snowmobiles and motorcycle riding. Skiing and motorized riding can potentially involve falls, collisions and minor to major accidents in extreme conditions such as snow, ice and water puddles. This means that a more durable item is needed regarding hand warming devices. It is conceivable that the aforementioned hazards also relate to other potentially cold-weather activities such as snowmobiles and even motorcycles. The present invention satisfies this need by protecting its power source within the confines of the ski pole or handlebar handgrip. Through that level of protection, the skier or motorized rider merely has to connect his or her gloves to wired or wireless conduits that transfer this power to the heating elements within the gloves. This connection between the ski pole or handlebar handgrip and glove is easily connected or removed, and compensates for accidents or other issues.

### SUMMARY OF THE INVENTION

The present invention is a heating system. More specifically, the system employs batteries or other comparable power sources to transfer power from the ski pole handgrips through a conventional conduit to a connection located at the sleeve end of each glove or glove liner. This power will activate conventional heating elements such as filaments that are sewn at strategic locations within the gloves. Upon activation, the heating elements will safely generate heat inside the gloves to the hands and fingers. The present invention may be wired as described in the preferred embodiment or wireless as other embodiments reveal. In addition, the wireless embodiment can relate to the handgrips of either a ski pole or the handgrips of a handlebar for a snow mobile or motorcycle.

The power source of the present invention is placed inside the hollowed interior of the ski pole handgrip. In the preferred embodiment, battery-housing elements having the positive and negative aspects will be included within each ski pole handgrip. Corresponding batteries will then be dropped into the ski pole handgrips before the handgrips are closed to secure these batteries. Because conventional battery-housing elements and their corresponding 9-volt, AA or AAA batteries are lightweight, only a few ounces of additional weight will be levied against the skier. For most recreational skiers, whether it is downhill or cross-country, this additional weight will be insignificant.

The system of the present invention also includes two conventional conduits that are connected to the battery housing. These conduits in the preferred embodiment are wires—one for each ski pole handgrip. Each conduit will lead to a connection point located at the sleeve end of each glove or glove liner. For example, the conduit associated with the left ski pole handgrip will serve as a power transfer connection between the left ski pole handgrip and the left glove. The same process pertains to the right ski pole handgrip and right glove. It is conceived that each conduit can run inside each ski pole wrist strap to consolidate the wire within a more condensed space. A break away mechanism also would be employed at the connection point of each glove so that if the ski pole becomes separated from the skier through any circumstance such as fall, crash or voluntary, the break away mechanism will automatically disconnect the conduit from the connection point upon a specified amount of force.

Each glove of the present invention contains heating elements that are sewn throughout the glove into the interior fabric. A glove liner also may be used so that the present invention can be applied to existing gloves. In the preferred embodiment, the heating elements will consist of filaments that are interconnected via conventional means by smaller conductive wires that are intermingled within the glove fabric. These conductive wires lead back to the connection point where the conductive wires can accept the current emanating from the power source through the conduit. The filaments in the preferred embodiment then receive the power via conventional means, causing heat. Other heating elements, having electrically charged heat transmitting gel, also are considered. However, it should be noted that the heating elements will be located at the top of the glove or glove liner interior, as well as bottom, so that all portions of the hand is kept warm.

### BRIEF DESCRIPTION OF THE DRAWINGS

FIG. 1 is an environmental view of the present invention relating to the ski pole handgrip.

FIG. 2 is an environmental view of the present invention relating to the glove.

FIG. 3 is an environmental view of the system of the present invention.

FIG. 4 is a view of the present invention in use.

FIG. 5 is an additional embodiment of the present invention relating to a wireless function.

FIG. 6 is an additional embodiment relating to the wireless function described in FIG. 5.

### DETAILED DESCRIPTION OF THE PREFERRED EMBODIMENT

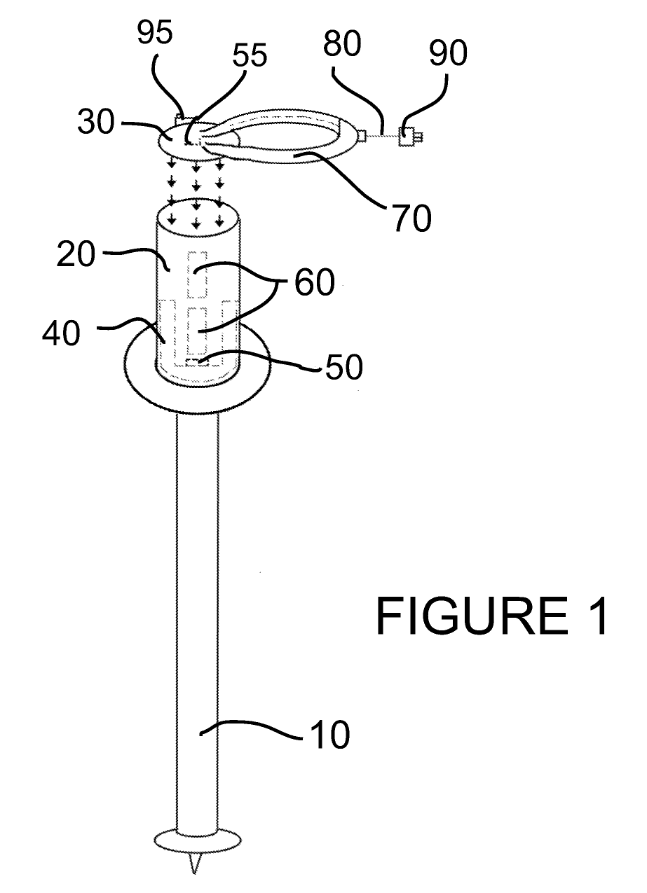

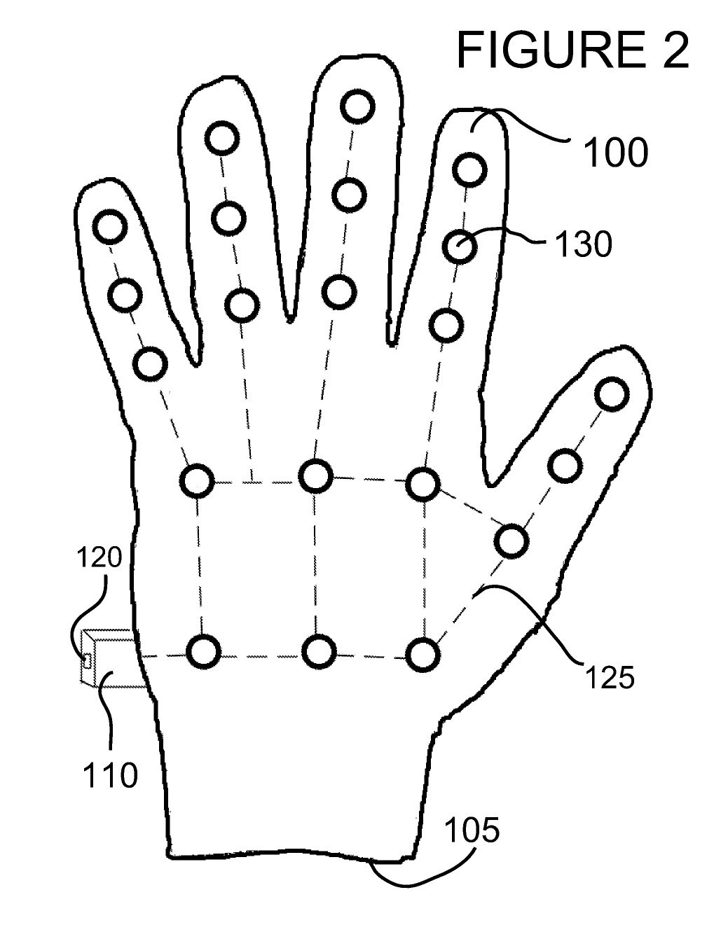

The present invention has two primary components relating to the ski pole (10) of FIG. 1 and the glove (100) of FIG. 2. When each of these elements of the system are merged through the components of the present invention, the ultimate result is that a skier's hands will be kept warm. It should be noted that while the primary example of this description is related to the context of a ski pole (10), the handgrip (20) and its associated functions of the overall system is conceived to also apply to other cold-weather activities such as snow mobiles and motorcycles that also use handgrips (20) and gloves (100).

FIG. 1 is an environmental view of a ski pole (10), and more particularly, the ski pole handgrip (20). As we see, the ski pole handgrip (20) is hollow. In addition, the preferred embodiment of the present invention permits the cap (30) to separate from the handgrip (20). In this embodiment, the cap (30) is configured to pop off or twist off of the handgrip (20). The cap (30) can then be snapped or twisted back into place. Additional embodiments permit the cap (30) to be connected to the handgrip (20) via a hinge mechanism so that the cap (30) is never completely separated from the handgrip (20) as the cap (30) is popped upward and then snapped back into place.

Inside the hollow portion of the ski pole handgrip (20), FIG. 1 depicts a power source casing (40). The example of FIG. 1 shows a power source casing (40) that is conventional in nature and would apply to a power source (60) such as batteries. For example, in FIG. 1 we see the conventional +/− component (50). Moreover, the same example of FIG. 1 shows the +/− opposite component (55) located within the interior portion of the cap (30). In this regard, a power source (60) may be placed inside the hollow portion of the handgrip (20) where the complete electrical connection would be closed upon snapping the cap (30) back into its place. In this manner, the power source (60) is isolated from outside elements due to its location inside the hollow interior of the handgrip (20). It is conceived that the power source (60) can include conventional rechargeable or non-rechargeable batteries such as 9-volt, AA or AAA. In the additional embodiment featuring rechargeable power as the power source (60), it is conceived that there would be little need to remove the cap (30), and instead a small plug accessory and plug insertion point attached to the handgrip (20) would be used to recharge the power source (60). The configuration of the small plug accessory and plug insertion point serves to allow the handgrip (20), and consequently, the power source (60), the ability to receive the recharging current. In any embodiment of the present invention, the power source (60) is protected from the elements based on its natural protection within a sealed ski pole handgrip (20). This means that the power source (60) will not be disturbed by snow, ice and puddle water.

As is the case with most ski pole handgrips (20), a wrist strap (70) is attached. The wrist strap (70) is typically used to help prevent separation between the skier and the ski pole (10). In the preferred embodiment of the present invention, a conduit (80) is contained within the wrist strap (70). The conduit (80) is essentially a conventional wire that carries electricity from the power source (60) and its corresponding elements such as the power source casing (40), +/− component (50) and +/− opposite component (55).

The example of FIG. 1 displays an embodiment of the present invention where the conduit (80) is located within the wrist strap (70) but then exits the wrist strap (70), providing a small amount of slack for the conduit (80). Additional embodiments avoid this extra amount of slack for the conduit (80). At the end of the conduit (80) is a conduit plug (90). The conduit plug is conventional in its function of being secured to the equally conventional connection point (110). The connection point (110) is viewed in FIG. 2.

In FIG. 2 we see an environmental view of a glove (100) of the present invention. While the image depicted in FIG. 2 is a glove (100), it also is conceived that the system can employ a mitten. In addition, the glove (100) of the present invention does not necessarily need to be a conventional type of glove (100), but instead may merely be a glove liner. In the embodiment relating to the glove liner aspect, nothing is substantially different in terms of function or placement of the components of the system. Instead, a skier would merely place the glove liner onto his or her hand, and then place another glove over the glove liner. Hereinafter, the glove (100) terminology also includes glove liner.

The glove (100) is comprised of conventional material conducive to fit over a skier's hand. While FIG. 2 displays a glove (100) for the left hand, it is understood that a right hand glove (100) also is used with equal function. Near the sleeve end (105) of the glove (100) is the connection point (110). The connection point (110) is conventional and functions to connect the glove (100) with the power source (60) contained within the ski pole handgrip (20) via the conduit (80). In the preferred embodiment, the skier will insert the conduit plug (90) into the connection point (110). A locking mechanism (120) as seen in FIG. 2 is conceived in the preferred embodiment to permit the conduit plug (90) to snap into place within the connection point (110). An additional embodiment envisions that the locking mechanism (120) of each glove (100) will automatically retract and effectively disconnect the conduit plug (90) from the connection point (110) upon a specified amount of force. This function is important in the event that the ski pole (10) becomes separated from the skier through any circumstance such as fall, crash or voluntary means. An embodiment of this disconnecting function relates to conventional quick-release aspect or conventional magnetic connection to regulate the amount of force necessary to cause the conduit plug (90) to disconnect.

In FIG. 2, we see that the connection point (110) is followed by conductive wires (125). The conductive wires (125) are essentially thinner wires that can accept the current emanating from the power source through the conduit. The conductive wires (125) are sewn into the glove (100) interior fabric as they branch off throughout the glove (100). The purpose of the conductive wires (125) is to carry the power from the power source (60) to the heating elements (130) that also are sewn into the glove (100) interior fabric at strategically placed locations. The strategic locations include areas of the hand that typically need heat concentrations. The heating elements and the conductive wires (125) of the preferred embodiment are placed at both the top and bottom portion of the glove (100) so that heat is dispensed to all parts of the hand.

In the preferred embodiment, the heating elements will consist of filaments that are interconnected via conventional means by the smaller conductive wires (125) that are intermingled within the glove (100) interior fabric. The filaments of this embodiment would be highly resistant. As mentioned above, the conductive wires (125) lead back to the connection point (110) where the conductive wires (125) can accept the current emanating from the power source (60) through the conduit (80). The heating elements (130) in the preferred embodiment then receive the power via conventional means, causing heat. As we see in FIG. 2, the heating elements (130) are placed at various locations throughout the hand. Besides using filaments as heating elements (130), other items also are envisioned employing electrically charged heat transmitting gel. The embodiment of the present invention employing electrically charged heat-transmitting gel operates via conventional means.

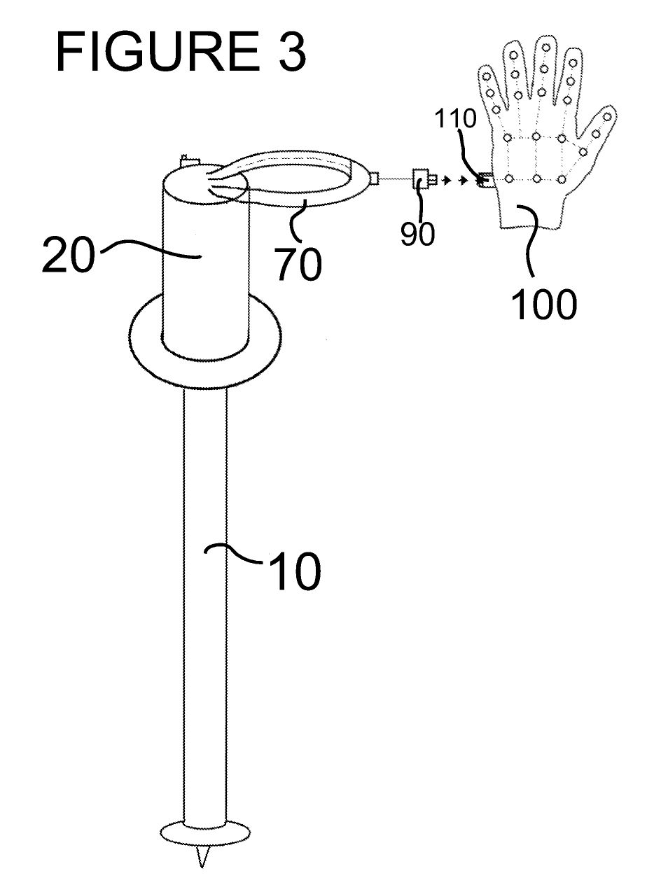

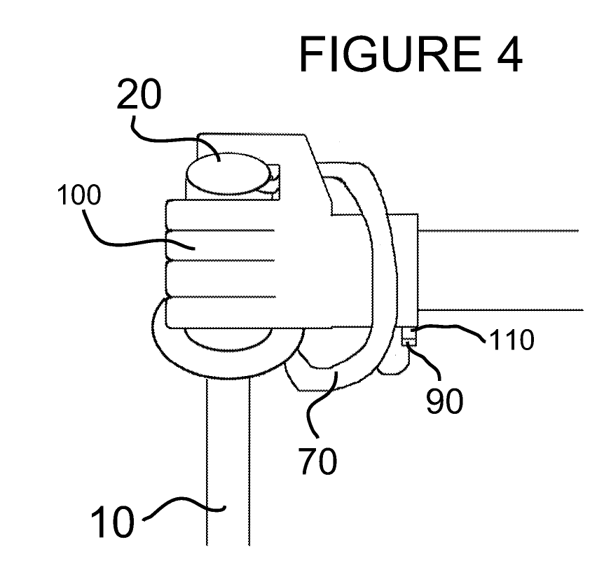

FIG. 3 offers an environmental view of the present invention with all components connected. FIG. 4, meanwhile, displays an additional view as the system of the present invention might look during actual use. As we see in FIG. 3, the power source (60) is contained within the interior of the handgrip (20). The cap (30) also is secure to the top of the handgrip (20). As mentioned above, an additional embodiment of the present invention envisions the use of rechargeable power as the power source (60) that is located within the handgrip (20). Since the cap (30) is closed in FIG. 3, we see that the conduit (80) is contained within the wrist strap (70) in an unobtrusive location. The conduit plug (90) of FIG. 3 is secured to the connection point (110) that is part of the glove (100). In the example of FIG. 3, the system will be functional in that the power from the power source (60) will be transferred via the conduit (80) and ultimately through the connection point (110) to the glove (100). From the glove (100), the power continued to travel through the conductive wires (125), which in turn lead the power to connections at the various heating elements (130) positioned throughout the glove (100).

An additional embodiment employs conventional means to automatically shut off the power output once the conduit plug is separated from the connection point. A further additional embodiment includes a small power adjustor (95) as seen in FIG. 1 and FIG. 3. While not necessary for the overall function of the present invention, the power adjustor (95) operates via conventional means and serves as a sliding mechanism that acts in similar fashion to a potentiometer. In this regard, the skier may slide the power adjustor (95) to varying levels of power that ultimately increase or decrease the amount of heat that is radiated from the heating elements.

FIG. 4 is an additional view of the present invention. In FIG. 4, we see how the system might be used in practice. As depicted in FIG. 4, it is displayed that a skier is wearing the glove (100). The skier's hand is grasping the handgrip (20) as any typical skier would. The skier also is using the wrist strap (70) for its intended purpose. As we see in FIG. 4, the conduit plug (90) is secured to the connection point (110) of the glove (100). It should be noted that an additional embodiment of the present invention avoids the excess conduit (80) as seen in FIG. 1, FIG. 3 and FIG. 4. In the additional embodiment, the conduit will still be included within the wrist strap (70) but only the conduit plug (90) will appear on the outside of the wrist strap (70) to connect with the connection point (110) of the glove (100).

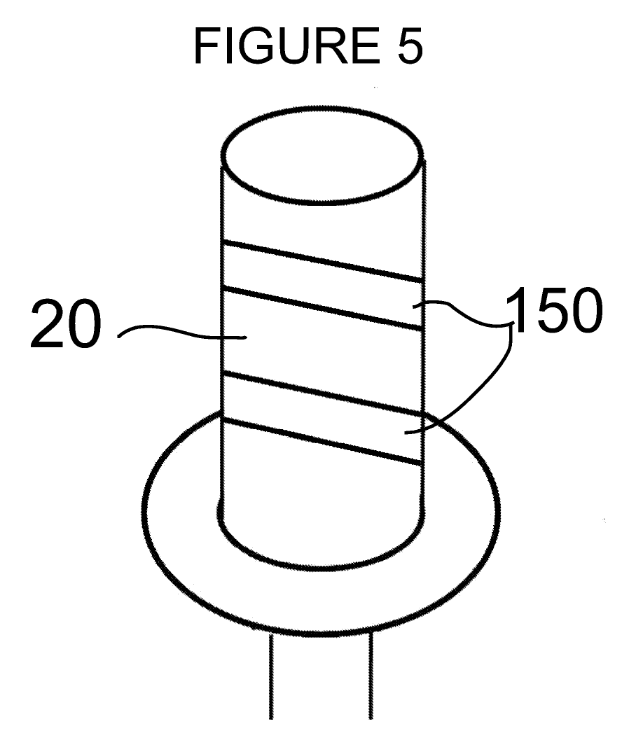

An additional embodiment of the present invention as seen in FIG. 5 employs the use of a ski pole handgrip (20) interface (150) for each ski pole or handlebar that operate in conjunction with contact points located on the gloves (100). This is a wireless embodiment that serves the same purpose and function of the embodiments described above. However, as FIG. 5 illustrates, the handgrip (20) contains an interface on its exterior. The interface (150) is operated via conventional means and includes wide, soft metal contact bands. The interior of the handgrip (20) continues to serve as housing for the power source (60). By being housed within the hollow interior of the handgrip (20), the power source (60) is isolated from the environment outside of the handgrip (20). The glove (100) of this additional embodiment, meanwhile, employs at least one magnetic contact point on each glove (100). These magnetic contact points may be exposed on the true exterior of the glove (100) or sewn into the fabric just below a silicone cover or via two bands of small raised metal studs. When the user grasps the handgrip (20) with his or her glove (100), the interface and the magnetic contact points operate in conjunction via conventional means and powered by the power source (60) located within the handgrip (20) as heat radiates into the glove (100) interior. In other words, the circuit is completed between the power source (60) and the heating elements (130).

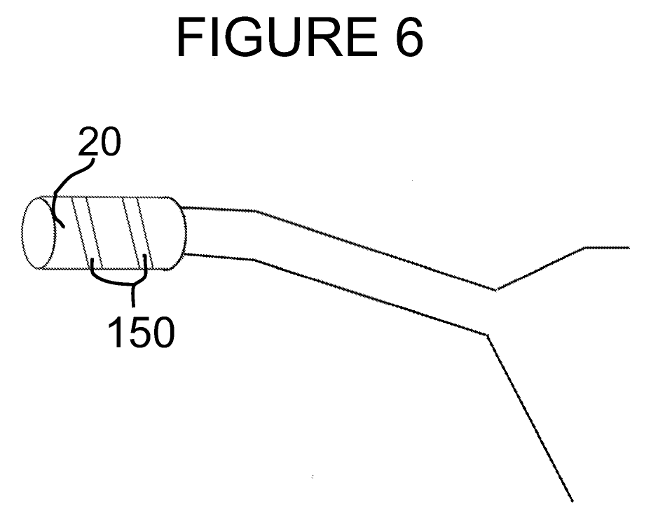

FIG. 6 is related to the wireless function described in FIG. 5. In the embodiment of FIG. 6, the purpose and function of the embodiment is the same as detailed above. However, the handgrip (20) is not attached to a ski pole (5) but rather a handlebar of a light motorized vehicle such as a conventional motorcycle or snow mobile. Other than the ski pole element, the embodiment operates in the same manner as the embodiment of FIG. 5. The handgrip (20) contains an interface (150) on its exterior. The interface (150) is operated via conventional means and includes wide, soft metal contact bands. The interior of the handgrip (20) continues to serve as housing for the power source (60). The glove (100) of this additional embodiment, meanwhile, employs at least one magnetic contact point on each glove (100). These magnetic contact points may be exposed on the true exterior of the glove (100) or sewn into the fabric just below a silicone cover or via two bands of small raised metal studs. When the user grasps the handgrip (20) with his or her glove (100), the interface (150) and the magnetic contact points operate in conjunction via conventional means and powered by the power source (60) located within the handgrip (20) as heat radiates into the glove (100) interior. In other words, the circuit is completed between the power source (60) and the heating elements (130). A primary difference between the glove (100) of this embodiment over the other embodiments described is that in this embodiment, the glove (100) would locate its heating elements (130) on the backside of the glove (100).

With the embodiment of FIG. 6, it also is conceived that power could come from the actual snowmobile or motorcycle. In this embodiment, the glove (100) aspects remain the same as described above. However, the interior of the handgrip (20) would include a power source accessory or other item that is wired from the interior of the handgrip (20) and through the interior of the snowmobile or motorcycle handlebar. The power source accessory then would work to transfer the power emanating from the snowmobile or motorcycle to the interface (150) and ultimately serve the function as described above. It also should be noted that all of the wireless embodiments of the present invention described also are envisioned in alternative embodiments to include either raised or flat contact points between the interface (150) and the glove (100). For example, the interface (150) of the handgrip (20) would be flat while the glove (100) magnetic contact points would be little metal spikes. Of course other embodiments also are conceived where the user wears the glove (100) and holds the handgrip (20) when the user wants to receive heat on the hand. In that scenario, the power source (60) located inside the handgrip (20) heats the glove (100) via its heating elements (130). When the user releases the glove (100) from the handgrip (20), it breaks an electrical circuit between the power source (60) and the glove (100). The breaking of the electric circuit upon release effectively occurs when the magnetic contact points of the glove (100) stop touching the interface (150) of the handgrip.

An additional embodiment of the present invention employs the use of inductive charging. In this embodiment, the charging base station is placed inside the ski pole handgrip (20) in the same position as the power source (60) of the preferred embodiment. The embodiment relating to inductive charging operates via conventional means in that the charging base station, along with an induction coil, remains sealed and isolated from the outside elements within the handgrip (20). While the electromagnetic field from within the handgrip (20) takes effect similar to the interface (150) function of the above embodiment, the second induction coil located on the gloves (100)—generally in the location of the connection points (110)—take power from this electromagnetic field via an interface and convert it into energy. This process would then operate via conventional means to carry the power through the conductive wires (125) and into the heating elements (130). This embodiment therefore operates as a wireless version of the preferred embodiment.

It should be noted that the handgrips also do not necessarily need to be attached to a recreational item such as a ski pole or handlebar. For example, it is conceived that a user may take the handgrips of the present invention and place them in a pocket. This embodiment permits the user to utilize the same function as described above in terms of the wired or wireless embodiments. But instead of gripping the handgrip of a ski pole or snow mobile, the user will use a glove of the present invention to grip at least one handgrip that is located in his or her pocket. This would benefit snowboarders in particular, as well as hikers, walkers, canoe riders or virtually anybody else operating outdoors in cold conditions.

Having illustrated the present invention, it should be understood that various adjustments and versions might be implemented without venturing away from the essence of the present invention. The present invention is not limited to the embodiments described above, and should be interpreted as any and all embodiments within the scope of the following claims.

I claim:

1. A heating system, comprising:
a power source;
at least one handgrip configured to house said power source;
at least one glove configured to receive power from said power source; and
heating elements in communication with said glove, said heating elements configured to convert the power into heat.

2. The heating system of claim 1, wherein said power source is rechargeable.

3. The heating system of claim 1, wherein said at least one handgrip is configured to lock said power source in place.

4. The heating system of claim 1, wherein said power source that is housed in said at least one handgrip, is isolated from an environment outside of said at least one handgrip.

5. The heating system of claim 1, further comprising a conduit that is configured to enable said at least one glove to receive power from said power source.

6. The heating system of claim 5, wherein said conduit is in a wrist strap.

7. The heating system of claim 1, further comprising conductive wires disposed at strategic locations throughout said at least one glove.

8. The heating system of claim 7, wherein said conductive wires are configured to lead power to said heating elements.

9. The heating system of claim 2,
wherein said at least one handgrip is configured to lock said power source in place;
wherein said power source that is housed in said at least one handgrip, is isolated from an environment outside of said at least one handgrip;
further comprising a conduit that is configured to enable said at least one glove to receive power from said power source;
wherein said conduit is in a wrist strap;
further comprising conductive wires disposed at strategic locations throughout said at least one glove; and
wherein said conductive wires are configured to lead power to said heating elements.

10. The heating system of claim 1, further comprising an interface on said at least one handgrip that is configured to enable said at least one glove to receive power from said power source.

11. The heating system of claim 1, further comprising at least one magnetic contact point on said at least one glove.

12. The heating system of claim 10, further comprising at least one magnetic contact point on said at least one glove.

13. The heating system of claim 12, wherein said interface and said at least one magnetic contact point complete a circuit between said power source and said heating elements.

14. The heating system of claim 2,
wherein said at least one handgrip is configured to lock said power source in place;
wherein said power source that is housed in said at least one handgrip, is isolated from an environment outside of said at least one handgrip;
further comprising an interface that is configured to enable said at least one glove to receive power from said power source;
further comprising at least one magnetic contact point on said at least one glove; and
wherein said interface and said at least one magnetic contact point complete a circuit between said power source and said heating elements.

15. A heating system, comprising:
wearing a glove;
holding a handgrip; and
heating the glove via a power source in the handgrip.

16. The heating system of claim 15, further comprising releasing the handgrip and breaking an electrical circuit between the power source and the glove.

17. The heating system of claim 16, wherein the glove has at least one heating element.
